(19) United States
(12) Patent Application Publication
(10) Pub. No.: US 2013/0129900 A1
(43) Pub. Date: May 23, 2013

(54) NON-DAIRY PROTEIN BEVERAGE PRODUCTS

(71) Applicants: Sandhya Sridhar, Dublin, OH (US); Stephen Mark, Dublin, OH (US); Christian Milo, Savigny (CH); Alexander A. Sher, Dublin, OH (US); Madhavi Ummadi, Bakersfield, CA (US); Madansinh Nathusinh Vaghela, Bakersfield, CA (US); Aaron Beth Butterworth, Bakersfield, CA (US); Nirav Chandrakant Pandya, Bakersfield, CA (US); Bridgett Lynn McCune, Bakersfield, CA (US); Christophe Joseph Etienne Schmitt, Servion (CH)

(72) Inventors: Sandhya Sridhar, Dublin, OH (US); Stephen Mark, Dublin, OH (US); Christian Milo, Savigny (CH); Alexander A. Sher, Dublin, OH (US); Madhavi Ummadi, Bakersfield, CA (US); Madansinh Nathusinh Vaghela, Bakersfield, CA (US); Aaron Beth Butterworth, Bakersfield, CA (US); Nirav Chandrakant Pandya, Bakersfield, CA (US); Bridgett Lynn McCune, Bakersfield, CA (US); Christophe Joseph Etienne Schmitt, Servion (CH)

(73) Assignee: NESTEC S.A., Vevey (CH)

(21) Appl. No.: 13/813,879

(22) PCT Filed: Aug. 4, 2011
(86) PCT No.: PCT/EP11/63461

§ 371 Date: Feb. 1, 2013

Related U.S. Application Data
(60) Provisional application No. 61/370,887, filed on Aug. 5, 2010.

(51) Int. Cl. A23L 2/66

(52) U.S. Cl. CPC A23L 2/66
USPC 426/590; 426/399

(57) ABSTRACT

The present invention relates to a non dairy beverage products including products manufactured with superior creaminess. In particular, the invention is concerned with a partially denatured protein system induced by controlled denaturation of protein which imparts outstanding sensory attributes RTD beverage. A method for producing such beverage and product obtainable from the method are also part of the invention.

### FIELD OF THE INVENTION

The present invention relates to beverages composition. More specifically, the present disclosure is directed to ready to drink (“RTD”) beverages. The present invention relates non dairy protein containing beverages and the method to produce the same.

In particular, the invention is concerned with a non dairy beverage composition comprising a partially denatured protein system which contributes to the improvement of textural and sensorial attributes of the beverages composition including products based on lower fat.
A method of producing such beverages composition and the products obtainable from the method are also part of the present invention.

### BACKGROUND OF THE INVENTION

Many technical routes have been explored in the prior art to improve the sensorial properties of food and beverages compositions.

There is a need for non dairy beverage products having an improved the sensory profile in order to achieve a pleasant taste, texture and aroma and delivering the beneficial effects associated with denatured protein system.

### SUMMARY OF THE INVENTION

The present invention now solves the foregoing problems by providing a non dairy beverage product (or beverage composition) more particularly a ready to drink (“RTD”) beverage having enhanced or improved organoleptic properties.

In a first aspect, the invention relates to a non dairy beverage product (or beverage composition) comprising a partially denatured protein system. In a first embodiment the protein system is from Soy (preferably Soy Glycinin or conglycinin.

In a second enmbodiment the protein system is an egg protein system (preferably Ovalbumin or Ovaglobulins.
In a third embodiment, the protein system is rice proteins.
In a fourth embodiment, the protein system is from Almond.
In a fifth embodiment, the protein system is from wheat (preferably Gluten).

The non dairy beverage according to the invention has a pH comprised between 5.8 and 6.1 during the heat treatment at 68-93° C. for 3-90 minutes.

In a second aspect, the present invention relates to a non dairy beverage product which uses the defined above composition as a base in part or as the whole.

The products of the invention present excellent organoleptic properties, in particular in terms of texture and mouthfeel even when very low levels of fat are used. Besides, the products of the invention show good stability and can therefore advantageously allow avoiding the use of non-natural additives.

In a further aspect, the invention pertains to the use of a partially denatured protein for manufacturing a liquid non dairy beverage product.

The invention also relates to a method of producing a non dairy beverage product more particularly a ready to drink (“RTD”) beverage wherein heat, acidic conditions and time are applied to the beverage composition or beverage as a whole, in a way to provide a partially denatured protein system within the beverage.

In another embodiment the invention relates to a method of producing a non dairy beverage product particularly a ready to drink (“RTD”) beverage comprising the steps of
a) providing an ingredient mix (Protein, water, acidic component) with a pH comprised between 5.5 and 6.5, preferably between 5.8 and 6.1, wherein the proteins content is preferably in an amount of 0.5 to 10% by weight, and an acidic component (Such as citric acid or phosphoric acid);
b) Heat treating of the above composition at 68-93° C. for 3 to 90 minutes
c) Optionally adding other ingredients after the step b such as fat, preferably in an amount of 0 to 10% by weight, a sweetening agent, preferably in an amount of 0 to 30%, a stabiliser system, preferably in an amount of 0 to 2% and colorants, flavours, vitamins, minerals or other functional ingredients.
d) Homogenising the liquid beverage using a one or two step high pressure homogenizer
e) Pasteurising (73-80° C. for 15 seconds)/Sterilizing (UHT at 136-150° C. for 3-15 second or retorting at 121° C. for 5 minutes or equivalent) the final beverage
f) Filling either aseptically for UHT in flexible carton or PET or similar containers, and filling before retorting for canned beverages.

In an other embodiment the non dairy beverage composition of the invention is a non dairy beverage concentrate. In such embodiment the levels of the ingredients should be proportionally increased according to the degree of concentration.

The products obtainable by these methods or the use mentioned above also form an embodiment of the present invention.

The products obtainable by these methods or the use mentioned above also form an embodiment of the present invention.

In the products of the invention, the partially denatured protein system preferably includes, soy (Glycinin or con-glycinin), rice, almond, wheat, egg (Ovalbumin or ovoglobulin)) or mixtures thereof that have been denatured by a heat treatment in a mild acidic environment

More particularly, the partially denatured protein systems of the products of the invention include proteins in the form of complexes or aggregates. The partially denatured non dairy protein system is generally present in an amount sufficient to provide a smooth and creamy texture to the liquid beverage to which it is added or in which it is formed.

### BRIEF DESCRIPTION OF THE DRAWING FIGURES

The invention is further illustrated in the following drawing figures, wherein:

FIG. 1 illustrates particle diameters of the denatured soy protein systems of the present invention. As shown in the FIG. 1, the heat/acid/time treatment results in an increase in the particle size diameter.

### DETAILED DESCRIPTION OF THE INVENTION

In the following description, the % values are in wt % unless otherwise specified.

The invention pertains to non dairy beverage product more particularly a ready to drink (“RTD”) beverage which texture and mouthfeel is improved as a result of an optimized preparation including the controlled use of heat acidic conditions and time.

In a preferred embodiment, the invention relates to a non dairy beverage product more particularly a ready to drink (“RTD”) beverage comprising a partially denatured protein system including soy preferably Soy Glycinin or conglycinin wherein said product has a pH comprised between 5.5 and 6.5, preferably between 5.8 and 6.1.

In another preferred embodiment, the invention relates to a non dairy beverage product more particularly a ready to drink (“RTD”) beverage comprising a partially denatured egg protein system preferably Ovalbumin or Ovaglobulins, wherein said product has a pH comprised between 5.5 and 6.5, preferably between 5.8 and 6.1.

In a preferred embodiment, the invention relates to a non dairy beverage product more particularly a ready to drink (“RTD”) beverage comprising a partially denatured rice protein wherein said product has a pH comprised between 5.5 and 6.5, preferably between 5.8 and 6.1.

In a preferred embodiment, the invention relates to a non dairy beverage product more particularly a ready to drink (“RTD”) beverage comprising a partially denatured almond protein wherein said product has a pH comprised between 5.5 and 6.5, preferably between 5.8 and 6.1.

In a preferred embodiment, the invention relates to a non dairy beverage product more particularly a ready to drink (“RTD”) beverage comprising a partially denatured wheat protein system preferably Gluten, wherein said product has a pH comprised between 5.5 and 6.5, preferably between 5.8 and 6.1.

Claim 1 of the invention deals the with a non dairy beverage composition comprising a partially denatured protein system wherein said protein system has a pH comprised between 5.5 and 6.5, preferably between 5.8 and 6.1 during the pre-heat treatment at 68-93° C. for 3-90 minutes.

Claim 2 of the invention deals with the beverage according to claim 1 comprising 0.5-10% by weight of protein, 0-10% by weight fat, 0-1% by weight stabilizing agent, 0-30% by weight of sweetening agent, and 0-1% by weight a stabiliser system including an emulsifier and or hydrocolloid.

Claim 3 of the invention deals with the beverage according to any one of claims 1 to 2 characterized in that it is partially or completely free of any artificial or non-natural emulsifier or stabilizer.

Claim 4 of the invention deals with the beverage according to any of the preceding claims characterized in that it is pasteurized, sterilized, or retorted. (Retorting is the thermal processing of RTD beverages in Cans for a specified temperature in order to sterilize the beverage).

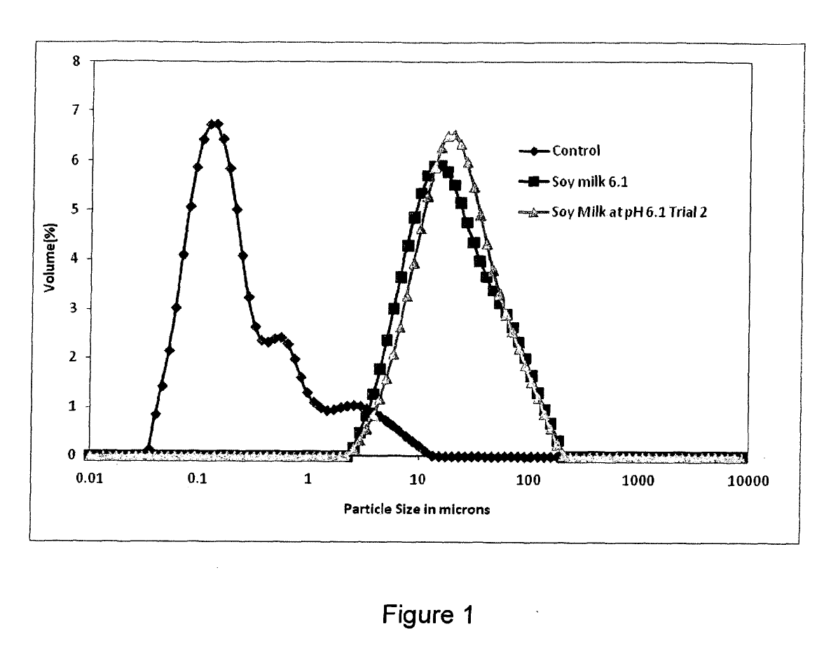

Claim 5 of the invention deals with the beverage according to any of the preceding claims characterized in that it has protein aggregates with an averaged diameter of particle size peak or group of particles greater than 45 microns, preferably greater than 100 microns, and lower than 300 microns, and with a more preferred range of 75 microns to 150 microns as measured by a particle size analyzer. Particle size analyser measures the diameter of the particles and gives the information in the form of a peak. (See FIG. 1.)

Claim 6 of the invention deals with the beverage of any of the preceding claims wherein the non dairy protein is taken from soy, rice, almond , wheat or egg.

Claim 7 of the invention deals with the beverage according to anyone of the preceeding claims wherein the non dairy protein is Soy Glycinin or soy conglycinin or a combination thereof.

Claim 8 of the invention deals with the beverage of any of the preceding claims being a liquid ready-to-drink beverage.

Claim 9 of the invention deals with a method of producing a NON DAIRY beverage comprising the steps of:
a) providing an beverage composition with a pH comprised between 5.5 and 6.5, preferably between 5.6 and 6.1 and comprising 0.5 to 10% proteins by weight and an acidic component, and further optionally comprising fat, preferably in an amount of 0 to 10% by weight, optionally comprising a sweetening agent, preferably in an amount of 0 to 30% by weight, optionally comprising a stabiliser system, preferably in an amount of 0 to 1% by weight;
b) the heat treating at 68-93° C. for 3-90 minutes;
c) homogenising the beverage;
d) Pasteurising at 73-80° C. for 15 seconds, or sterilizing at UHT conditions at 136-150° C. for 3-15 seconds, or retorting at 121° C. for 5 minutes or equivalent;
e) Filling either aseptically for UHT beverages in flexible carton or PET or similar containers, and filling before retorting for canned beverages.

Claim 10 of the invention deals with a method to manufacture a beverage according to claim 1, wherein the beverage composition comprises an acidic component selected from an organic acid such as citric acid, an inorganic acid such as phosphoric acid, fruit derived acids or fermentation derived acids

Claim 11 of the invention deals with a beverage obtainable by the method of any one of claims 9 and 10.

12. Claim 12 of the invention deals with the use of a partially denatured protein system comprising acids for manufacturing of RTD beverages.

### Liquid Beverage Composition and Product

A non dairy beverage composition according to the invention may be any beverage composition, meant to be consumed by a human or animal, such as e.g. a beverage, e.g. a coffee beverage, a cocoa or chocolate beverage, a malted beverage, a fruit or juice beverage, a carbonated beverage, a soft drink, or a milk based beverage; a performance nutrition product, e.g. a performance nutrition bar, powder or ready-to-drink beverage; a medical nutrition product; a dairy product, e.g. a milk drink, a yogurt or other fermented dairy product; an ice cream product; a confectionary product, e.g. a chocolate product; a functional food or beverage, e.g. a slimming product, a fat burning product, a product for improving mental performance or preventing mental decline, or a skin improving product.

### Beverage or Beverage Composition

A non dairy beverage according to the invention may e.g. be in the form of of liquid or liquid concentrate to be mixed with a suitable liquid, e.g. water or milk, beforeconsumption, or a ready-to-drink beverage. By a ready-to-drink beverage is meant a beverage in liquid form ready to be consumed without further addition of liquid. A beverage according to the invention may comprise any other suitable ingredients known in the art for producing a beverage, such as e.g. sweeteners, e.g. sugar, such as invert sugar, sucrose, fructose, glucose, or any mixture thereof, natural or artificial sweetener; aromas and flavours, e.g. fruit, cola, coffee, or tea aroma and/or flavour; fruit or vegetable juice or puree; milk; stabilizers; emulsifiers; natural or artificial colour; preservatives; antioxidants, e.g. ascorbic acid; and the like.

Any suitable acid or base may be used to achieve a desired pH of the product, e.g. citric acid or phosphoric acid. A beverage of the invention may be carbonated, carbon dioxide may be added by any suitable method known in the art. In a preferred embodiment a beverage comprises up to 10% sucrose or another sweetener in an amount yielding an equal degree of sweetness, more preferably between 2% and 5% sucrose or another sweetener in an amount yielding an equal degree of sweetness. If the beverage is a liquid concentrate or a ready-to-drink beverage it may be subjected to a heat treatment to increase the shelf life or the product, e.g. by retorting, UHT (Ultra High Temperature) treatment, HTST (High Temperature Short Time) treatment, pasteurisation, or hot fill.
Examples of non dairy beverages according to the invention are

Flavored and unflavored soy milk beverages

Flavored and unflavored rice milk beverages

Flavored and unflavored almond milk beverages

Flavored and unflavored drinks containing wheat gluten beverages

Flavored and unflavored drinks containing egg albumen beverages

The products of the invention are characterised by the presence of a partially denatured protein system.

The term “partially denatured protein system” is to be understood to mean a complex or an aggregate resulting from at least a partial coagulation of proteins present in the ingredient mix, for instance induced by the presence of an acid component combined with a heat treatment for the specific time. The denaturation process involves an unfolding or at least an alteration in the 3D structure of the proteins. The term denaturation refers to the response of the protein to any of the agents that cause makered changes in the protien structure. Such agens can include heat, acid, alkali, and a variety of other chemical and physical agents. The partially denatured protein system according to the invention is characterised by the presence of a significant particle size peak or group of particles greater than 45 microns, preferably greater than 100 microns, and lower than 300 microns. A more preferred range is 75 microns to 150 microns.

The applicant has discovered that texture and mouthfeel of beverage product more particularly of ready to drink (“RTD”) beverage is improved as a result of an optimized process of preparation including the controlled use of heat and acidic conditions and time. More particularly, by manipulating the protein structure by decreasing the pH and exposing the mix to controlled heat for a specific time, it is believed that protein denaturation and subsequent aggregation occurs as heat at these conditions changes the protein structure. These protein aggregates form aggregates that create a uniquely smooth, creamy texture that improves the body and mouth-feel.

The present invention thus relates in a first aspect to a non dairy beverage product more particularly a ready to drink (“RTD”) beverage comprising a partially denatured protein system.

The products of the invention comprise protein aggregates. One of the example is the formation of aggregates between soy glycinin. The formation of aggregates can be measured by coomassie blue gel electrophoresis analysis.

### Method:

For total sample, an aliquot of 10 g of flavoured non-dairy beverage was dispersed in 90 g of a deflocculating aqueous solution at pH 9.5 containing 0.4% EDTA and 0.1% Tween 20. The soluble phase was obtained by centrifugation of the flavoured non dairy beverage at 50,000 g for 30 min. Samples were then analyzed by gel electrophoresis on Nu-PAGE 12% Bis-Tris using the MOPS running buffer in reducing and non-reducing conditions (reducing conditions should break any covalent bound involving SH/SS exchange during heating) as described in “Invitrogen Nu-PAGE pre-cast gels instructions” (5791 Van Allen Way, Carlsbad, Calif. 2008, USA). Gels were stained with Coomassie blue (Invitrogen kit no.LC6025). The total sample and the corresponding soluble phase were deposited on the same electrophoresis gel at a concentration of 0.5 mg.mL⁻¹. After migration and staining with colloidal blue, the gels were scanned in 256 gray levels with a resolution of 1000 dpi using a UMAX scanner coupled with the

MagicScan 32 V 4.6 software (UMAX Data Systems, Inc.) leading to pictures having a size of 16 MB. These pictures were then analyzed using the TotalLab TL120 v2008.01 image analysis software (Nonlinear Dynamics Ltd, Cuthbert House, All Saints, Newcastle upon Tyne, NE1 2ET, UK). Migration lanes were detected automatically by the software. Then, image was corrected for background using the “rolling ball” option with a radius of 200. A Standard protein maker was used ranging from 20 kilo Daltons to 200 kilo daltons The intensity of the bands was converted into peak migration profiles for each migration lane for the total sample and the soluble phase. These peaks were then fitted with a Gaussian model in order to calculate their area for each protein, and thereby the concentration of the protein in the sample.

The peak area determined for a protein in the soluble phase was thereafter corrected by the effective protein content determined by the Kjeldahl method (described thereafter) and normalised by the peak area of the corresponding protein in the total sample The invention is also characterised by the fact that when centrifuged at 50′000 g for 30 min, the ratio of soluble protein to total protein is below 60%. The ratio of the soluble protein to the total protein in below 60% indicates that only part of the protein is denatured during the treatment. The ratio of the soluble and versus insoluble protein is important to maintain the functionality of the protein system in the beverage.
The amount of proteins present in the soluble phase after centrifugation can be measured by Kjeldahl method using a conversion factor of 6.38 for proteins.

### Kjeldahl Method:

Kjeldahl is a general method allowing the determination of total nitrogen, using a block-digestion apparatus and automated steam distillation unit.

This method is applicable to a wide range of products, including dairy products, cereals, confectionary, meat products, pet food, as well as ingredients containing low levels of protein, such as starches. Nitrogen from nitrates and nitrites is not determined with this method.

This method correspond to the following official methods: ISO 8968-1/IDF 20-1 (milk), AOAC 991.20 (milk), AOAC 979.09 (grains), AOAC 981.10 (meat), AOAC 976.05 (animal feed and pet food), with small modifications (adaptation of catalyst quantity and sulphuric acid volume for digestion, and adaptation of boric acid concentration for automated system).

Principle of the method: Rapid mineralisation of the sample at about 370° C. with sulfuric acid and Missouri catalyst, a mixture of copper, sodium and/or potassium sulfate, which transforms organically bound nitrogen to ammonium sulfate. Release of ammonia by addition of sodium hydroxide. Steam distillation and collection of the distillate in boric acid solution. Acidimetric titration of ammonium. Apparatus: Mineralisation and distillation unit in combination with a titration unit. Manual, semi-automated and automated conformations are possible.

These methods are known from a skilled person in the art of frozen confectionery who has a good knowledge of proteins.

According to a particular embodiment, the pH is controlled by the presence of an acidic component. The acid component is preferably selected from the group consisting of an organic acid such as citric acid, an inorganic such as phosphoric acid, fruit derived acids and fermentation derived acids.

According to a particular embodiment, the product according to the invention comprises 0.5 to 10% proteins by weight, 5, 0 to 10.0% fat by weight and 0 to 30% of a sweetening agent by weight.

By “sweetening agent” it is to be understood a mixture of ingredients which imparts sweetness to the final product. These include natural sugars like cane sugar, beet sugar, molasses, other plant derived nutritive sweeteners, and non-nutritive high intensity sweeteners.

The reduction of fat in beverages products is one of the main challenges faced by the industry. The present invention is overcoming this issue in providing low fat or even non-fat products with similar texture and sensory attributes than those having higher fat contents in terms of creaminess and body.

According to a specific embodiment, the product of the invention may include natural ingredients.

By “natural ingredients” what is meant are ingredients of natural origin. These include ingredients which come directly from the field, animals, etc. or which are the result of a physical or microbiological/enzymatic transformation process. These therefore do not include ingredients which are the result of a chemical modification process.

In another aspect of the invention, the non dairy beverage composition comprises a stabiliser system.
By “stabiliser system” is to be understood a mixture of ingredients which contributes to the stability of the liquid beverage. Thus, the stabiliser system may comprise any ingredients which are of functional importance to the beverage product of the invention. These stabilizers system might include hydrocolloids such as gums or starches.

The stabiliser system used in the present products preferably comprises at least one natural emulsifier.

Natural emulsifiers include for example egg yolk, buttermilk, raw acacia gum, rice bran extract or mixtures thereof. The natural emulsifiers have the advantage of conferring to the finished product a smoother texture and stiffer body which reduce the whipping time. The presence of natural emulsifiers results in air cells that are smaller and more evenly distributed throughout the internal structure of the ice cream. Preferably, the natural emulsifier used in the present stabiliser system is egg yolk. A typical range for this component is about 0.5 to 1.4% of solids from egg yolk.

According to another particular embodiment, the products of the invention comprises at least one non-natural emulsifier. Any food grade emulsifier typically used in beverages could be used. suitable emulsifiers include sugar esters, emulsifying waxes such as beeswax, carnauba wax, candedilla wax, plant or fruit waxes and animal waxes, polyglycerol fatty acid esters, polyglycerol polyricinoleate (PGPR), polysorbates

The product may additionally comprise flavourings or colourings and functional ingredients Such flavourings or colourings and functional ingredients, when used, are preferably selected from natural ingredients. These are used in conventional amounts which can be optimized by routine testing for any particular product formulation.

The beverage products as defined above can also be produced by conventional processing methods. The beverage products of the invention have a smoother mouth feel and particularly appealing textural and organoleptic properties, compared to beverages products known to date.

It has been surprisingly found out that the presence of this partially denatured protein system in the beverage of the invention improves the sensory profile of the product and in particular that it enhances considerably the smooth and creamy texture of RT beverage that contain this system.

The present invention is directed to a partially denatured by a specific heat treatment of proteins in acidic environment for the specific time. Proteins are but not limited to milk, soy, almond, rice wheat, egg, rye. This treatment considerably improves liquid beverage mouth-feel and body.

Furthermore, the product of the invention has proven to be particularly stable, both when stored as refrigerated as well as at ambient conditions

A method for producing the products of the invention also forms part of the invention, and more particularly a method of producing RTD beverages, comprising proteins which are partially denaturated within the beverages which are further homogenised, heat treated and filled into containers.

The process of the invention has surprisingly proven to enhance the textural experience of beverages even at lower fat levels. The applicant has discovered that the controlled reduction of the pH and heat treatment for specific time of the composition before processing combined with an optimized treatment parameters results in a product with smooth, creamy texture when compared to typical RTD products.

According to a particular embodiment, the beverage composition comprises an acidic component. Preferably the acid component is selected from the group consisting of, an organic acid such as citric acid, an inorganic acid such as phosphoric acid, other fruit derived acids and fermentation derived acids.

Homogenisation of the whole beverage can be done either prior or after heat treatment. It is preferably carried out under standard conditions, namely at a total pressure of between 40 and 300 bars, preferably between 100 and 190 bars, more preferably between 120 and 170 bars

The method of the invention lends itself to the manufacture of non dairy beverage product which are shelf-life stable at the necessary storage temperatures and have superior organoleptic and textural properties.

Thus, the present invention proposes a new way in which a RTD product which is stable and with superior sensory attributes may be manufactured.

### EXAMPLES

The present invention is illustrated further herein by the following non-limiting examples.

The general composition of the non dairy beverage product according to the invention contains: 0 to 10% by weight of Fat content, from 0.5 to 10% by weight of protein system (preferably selected from soy, rice, almond, wheat, or egg).

The non dairy beverage product according to the invention has a pH range comprised between 5.5 and 6.5, preferably between 5.8 and 6.1.

The pH may be adjusted using components from the group consisting of an inorganic acid such as phosphoric acid, an organic acid such as citric acid, fruit derived acids and fermentation derived acids.

TABLE 1
Flavoured soy protein beverage

| Ingredient | Wt % of final product |
|---|---|
| Fat | 1.0 |
| Sugar | 8.0 |
| Soy Protein | 9.0 |
| Hydrocolloid stabilizer | 0.02 |
| Flavouring | 0.2 |
| Cocoa Powder | 1.0 |

In a first variable, referred to as “Control 1”, conventional beverage making procedures were followed: in tank containing 900 g of water, 10 g of fat, 80 g of sugar, 90 g of soy protein, 3 g of hydrocolloid stabilizer (Carrageenan), 2 g of flavour and 10 g of cocoa powder under agitation and rest of water to achieve 1000 g of liquid. The liquid was pasteurised at 190° F. for 25 seconds and then homogenized at total pressure 170 bars.

TABLE 2a
Soy protein preparation (step1)

| Ingredient | Wt % of final product |
|---|---|
| Soy Protein | 9.0 |
| Acidic Component | Enough to reduce |
| | the pH to 5.8-6.3 |
| Water | 91 |

TABLE 2b
Flavoured soy beverage preparation

| Ingredient | Wt % of final product |
|---|---|
| Fat | 1.0 |
| Sugar | 8.0 |
| Soy Protein from | 9.0 |
| above (Table 2a) | |
| Hydrocolloid stabilizer | 0.02 |
| Flavouring | 0.2 |
| Cocoa Powder | 1.0 |

In a second variable, in a tank containing 91 g of water, 9 g of soy protein was added (Table 2a). Citric acid was added to lower the pH to 6.1. The liquid was then pre-heat treated at 77 C. for 3 minutes a partial denaturation of the protein This mix was uses as an ingredient in the next step to make the final beverage. In the second step, rest of the ingredients (Table 2b) were added with the soy preparation from step 1 to make the RTD beverage. Then the liquid was pasteurised at 190° F. for 25 seconds and then homogenized at total pressure 170 bars.

The RTD beverage made with the controlled reduction in pH, pre-heat treated at the specified time and temperature was significantly smoother and improved texture compared to “Control 1”. This was confirmed by the particle size distribution data where the treated mix has a higher particle size peak compared to control (See FIG. 1)

### Example 2

### Flavoured Soy Milk Beverage

TABLE 3

| Ingredient | Wt % of final product |
|---|---|
| Soy bean oil | 1.0 |
| Sugar | 8.0 |
| Soy Protein | 9.0 |
| Flavouring | 0.2 |

In a first variable, referred to as “Control 2”, conventional beverage making procedures were followed: in tank containing 900 g of water, 10 g of fat, 80 g of sugar, 10 g of soy protein and 2 g of flavour under agitation and rest of water to achieve 1000 g of liquid. The liquid was then pre-heat treated at 170° F. for 3 minutes. Then the liquid was pasteurised at 190° F. for 25 seconds and then homogenized at total pressure 170 bars.

In a second variable a similar composition was prepared but with addition of phosphoric acid to lower the pH to 6.3 before pasteurization. The liquid was then pre-heat treated at 170° F. for 3 minutes. Then the liquid was pasteurised at 190° F. for 25 seconds and then homogenized at total pressure 170 bars. This treatment results in the partial denaturation of the proteins.

The RTD beverage made with the controlled reduction in pH, pre heat treated at the specified time and temperature was significantly smoother and improved texture compared to “Control 2”

### Example 3

### Flavored Rice Milk Beverage

| Ingredient | Wt % of final product |
|---|---|
| vegetable oil | 1.0 |
| Sugar | 8.0 |
| Rice Protein | 4.0 |
| Flavouring | 0.2 |

In a first variable, referred to as “Control 3”, conventional beverage making procedures were followed: in tank containing 900 g of water, 10 g of fat, 80 g of sugar, 10 g of rice protein and 2 g of flavour under agitation and rest of water to achieve 1000 g of liquid. The liquid was then pre-heat treated at 170° F. for 3 minutes. Then the liquid was pasteurised at 190° F. for 25 seconds and then homogenized at total pressure 170 bars.

In a second variable a similar composition was prepared but with addition of phosphoric acid to lower the pH to 6.3 before pasteurization. The liquid was then pre-heat treated at 170° F. for 3 minutes. Then the liquid was pasteurised at 190° F. for 25 seconds and then homogenized at total pressure 170 bars. This treatment results in the partial denauration of the proteins.

The RTD beverage made with the controlled reduction in pH, pre heat treated at the specified time and temperature was significantly smoother and improved texture compared to “Control 3”

### Example 4

### Flavored Almond Milk Beverage

| Ingredient | Wt % of final product |
|---|---|
| Vegetable oil | 1.0 |
| Sugar | 8.0 |
| Almond protein | 4.0 |
| Flavouring | 0.2 |

In a first variable, referred to as “Control 4”, conventional beverage making procedures were followed: in tank containing 900 g of water, 10 g of fat, 80 g of sugar, 10 g of almond protein and 2 g of flavour under agitation and rest of water to achieve 1000 g of liquid. The liquid was then pre-heat treated at 170° F. for 3 minutes. Then the liquid was pasteurised at 190° F. for 25 seconds and then homogenized at total pressure 170 bars.

In a second variable a similar composition was prepared but with addition of phosphoric acid to lower the pH to 6.3 before pasteurization. The liquid was then pre-heat treated at 170° F. for 3 minutes. Then the liquid was pasteurised at 190° F. for 25 seconds and then homogenized at total pressure 170 bars. This treatment results in the partial denaturation of the proteins.

The RTD beverage made with the controlled reduction in pH, pre heat treated at the specified time and temperature was significantly smoother and improved texture compared to “Control 4”

### Example 5

### Flavored Wheat n Beverage

| Ingredient | Wt % of final product |
|---|---|
| Vegetable oil | 1.0 |
| Sugar | 8.0 |
| Wheat Protein | 4.0 |
| Flavouring | 0.2 |

In a first variable, referred to as “Control 5”, conventional beverage making procedures were followed: in tank containing 900 g of water, 10 g of fat, 80 g of sugar, 10 g of wheat protein and 2 g of flavour under agitation and rest of water to achieve 1000 g of liquid. The liquid was then pre-heat treated at 170° F. for 3 minutes. Then the liquid was pasteurised at 190° F. for 25 seconds and then homogenized at total pressure 170 bars.

In a second variable a similar composition was prepared but with addition of phosphoric acid to lower the pH to 6.3 before pasteurization. The liquid was then pre-heat treated at 170° F. for 3 minutes. Then the liquid was pasteurised at 190° F. for 25 seconds and then homogenized at total pressure 170 bars. This treatment results in the partial denauration of the proteins.

The RTD beverage made with the controlled reduction in pH, pre heat treated at the specified time and temperature was significantly smoother and improved texture compared to “Control 5”

### Example 8

### Flavored Egg Beverage

TABLE 1

| Ingredient | Wt % of final product |
|---|---|
| Vegetable oil | 1.0 |
| Sugar | 8.0 |
| Egg protein | 4.0 |
| Flavouring | 0.2 |

In a first variable, referred to as “Control 6”, conventional beverage making procedures were followed: in tank containing 900 g of water, 10 g of fat, 80 g of sugar, 10 g of egg protein and 2 g of flavour under agitation and rest of water to achieve 1000 g of liquid. The liquid was then pre-heat treated at 170° F. for 3 minutes. Then the liquid was pasteurised at 190° F. for 25 seconds and then homogenized at total pressure 170 bars.

In a second variable a similar composition was prepared but with addition of phosphoric acid to lower the pH to 6.3 before pasteurization. The liquid was then pre-heat treated at 170° F. for 3 minutes. Then the liquid was pasteurised at 190° F. for 25 seconds and then homogenized at total pressure 170 bars. This treatment results in the partial denauration of the proteins.

The RTD beverage made with the controlled reduction in pH, pre heat treated at the specified time and temperature was significantly smoother and improved texture compared to “Control 6”

FIG. 1: Particle size distribution of soy protein beverage with and without acid/temperature/time pre-treatment.

Particle size analysis was performed on both the control and treated samples in order to show the effect of the treatment on the protein denaturation. As expected, the treated samples showed a shift in the peak of particle size. This indicates that the heat treatment under acidic conditions for a specific time caused a partial denaturation of the proteins. When this sample was used for preparation of the final beverage and compared against the Control, it was found that the treated samples had more body and creamier mouthfeel indicating that the partial denuration results of the protein affects the organolepic properties of the beverage. Another observation from this experiment was that only heat treatment without acidic component did not cause the partial denuration as indicated by the Control sample which was processed (Same heat treatment for a specific time) in the exact same way as the “treated sample”

1. A non dairy beverage composition comprising a partially denatured protein system wherein the product has a pH of between 5.5 and 6.5, during a heat treatment at 68-93° C. for 3-90 minutes.

2. The beverage according to claim 1 comprising 0.5-10% by weight protein, 0-10% by weight fat, 0-1% by weight stabilizing agent, 0-30% by weight sweetening agent, and 0-1% by weight of a stabiliser system including an emulsifier and or hydrocolloid.

3. The beverage according to claim 1, wherein it is partially or completely free of any artificial or non-natural emulsifier or stabilizer.

4. The beverage according to claim 1, wherein it is pasteurized, sterilized, or retorted.

5. The beverage according to claim 1, wherein it has protein aggregates having an average diameter of particle size peak or group of particles greater than 45 microns and less than 300 microns as measured by a particle size analyzer.

6. The beverage of claim 1, wherein the non dairy protein is selected from the group consisting of soy, rice, almond, wheat and egg.

7. The beverage according to claim 1, wherein the non dairy protein is Soy Glycinin or soy conglycenin or a combination thereof.

8. The beverage of claim 1, wherein it is a liquid ready-to-drink beverage.

9. Method of producing a non dairy beverage comprising the steps of:
providing a beverage composition having a pH of between 5.5 and 6.5 and comprising 0.5 to 10% proteins by weight and an acidic component;
heat treating the composition at 68-93° C. for 3-90 minutes;
homogenising the beverage;
subjecting the beverage to a treatment selected from the group consisting of pasteurizing at 73-80° C. for 15 seconds, or sterilizing at UHT conditions at 136-150° C. for 3-15 seconds, or retorting at 121° C. for 5 minutes or equivalent; and
filling either aseptically for UHT beverages in flexible carton or PET or similar containers, and filling before retorting for canned beverages.

10. Method of manufacturing a beverage comprising the steps of producing a beverage composition comprising a partially denatured protein system wherein the product has a pH of between 5.5 and 6.5 during a heat treatment at 68-93° C. for 3-90 minutes, wherein the beverage composition comprises an acidic component selected from the group consisting of an organic acid, an inorganic acid, fruit derived acids and fermentation derived acids.

11. A beverage obtained by the method of claim 9.

12. Use of a partially denatured protein system comprising acids for manufacturing RTD beverages.

13. A beverage obtained by the method of claim 10.
